(19) United States
(12) Patent Application Publication
(10) Pub. No.: US 2026/0109806 A1
(43) Pub. Date: Apr. 23, 2026

(54) POROSITY-FREE PHENOLIC EPOXIES

(71) Applicant: Applied Materials, Inc., Santa Clara, CA (US)

(72) Inventors: Marcus Elias Nijmeh, San Jose, CA (US); Jenn-Yue Wang, San Jose, CA (US); Jonathan Orsborn, San Jose, CA (US); Jane Sun, Sunnyvale, CA (US); Gang Xiao, San Jose, CA (US); Laura Maben Gordon, Mountain View, CA (US)

(73) Assignee: Applied Materials, Inc., Santa Clara, CA (US)

(21) Appl. No.: 18/924,184

(22) Filed: Oct. 23, 2024

(51) Int. Cl. C08G 59/24; C08G 59/26

(52) U.S. Cl. CPC C08G 59/245; C08G 59/26

(57) ABSTRACT

A porosity-free phenolic epoxy to use as a fill for nanostructures, the phenolic epoxy including i) poly(tetrahydrofuran); ii) polyglycidyl ether of phenol-formaldehyde; iii) ethyl methyl ketone; and iv) a solvent such as isopropanol. The phenolic epoxy creates a uniform, void free fill that improves silicon wafer processing, metrology, and TEM analysis. A method to fill a nanostructure with a porosity-free phenolic epoxy, includes placing tetrahydrofuran in a strong acid such that a ring of the tetrahydrofuran is opened to create a tetrahydrofuran monomer, polymerizing the tetrahydrofuran monomer to create poly(tetrahydrofuran), mixing the poly(tetrahydrofuran) with polyglycidyl ether of phenol-formaldehyde, ethyl methyl ketone, and isopropanol, and depositing one or more layers of the porosity-free phenolic epoxy onto a surface of a nanostructure.

### TECHNICAL FIELD

The embodiments of the present disclosure relate to a gap filling compounds and, more particularly to novel phenolic compounds that fill gaps with minimal voids.

### BACKGROUND

Phenolic epoxies have a wide range of uses as a gap filling compound. In particular, phenolic epoxies are used in industries such as silicon wafer processing, metrology, and transmission electron microscopy (TEM) analysis.

Phenolic epoxies are often used in wafer processing in attempts to uniformly fill nanostructures. The phenolic epoxies can be used as an encapsulation and protection material for semiconductor packages. For example, the phenolic epoxy may fill the nanostructure to protect the features of the nanostructure beneath the phenolic epoxy. The phenolic epoxy may then be removed as a sacrificial layer to expose the features below.

TEM technologies allow user to identify spatial resolution and perform highly sensitive elemental analyses that can be used to for metrology and materials characterization of sub-nanometer sized device features in nanostructures and other nanoparticles. TEM techniques allow users to evaluate interfacial details, define the dimensions of device structures, and locate defects or flaws in nanostructure features. Phenolic epoxies, when filling the nanostructure, allows TEM analysis by providing a contrast to the nanostructure features when imaging.

Conventional phenolic epoxies, when added to a nanostructure, create voids in the phenolic epoxy fill. That is, the phenolic epoxy filled in the gaps of the nanostructure is porous and has pockets, bubbles, or voids in which the phenolic epoxy is not present. The voids prevent the phenolic epoxy from completely protecting the nanostructure features. The voids further prevent the phenolic epoxy from providing a clear interface and contrast to the nanostructure when being imaged, such as with a TEM technology. There remains a need in the art for phenolic epoxies that provide a porosity-free fill for the gaps in nanostructures.

### BRIEF SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter. This summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently disclosed subject matter, whether listed in this summary or not. To avoid excessive repetition, this Summary does not list or suggest all possible combinations of such features.

In one aspect, a porosity-free phenolic epoxy to use as a fill for nanostructures is provided. The phenolic epoxy includes i) poly(tetrahydrofuran); ii) polyglycidyl ether of phenol-formaldehyde; iii) ethyl methyl ketone; and iv) isopropanol. The phenolic epoxy creates a uniform, void free fill that improves silicon wafer processing, metrology, and TEM analysis. In some embodiments, the poly(tetrahydrofuran) may be formed from a polymerized tetrahydrofuran monomer. In some embodiments, the tetrahydrofuran monomer is formed from a tetrahydrofuran compound that has a ring structure of the tetrahydrofuran broken in a strong acid.

In another aspect, a method to fill a nanostructure with a porosity-free phenolic epoxy is provided. The method includes placing tetrahydrofuran in a strong acid such that a ring of the tetrahydrofuran is opened to create a tetrahydrofuran monomer, polymerizing the tetrahydrofuran monomer to create poly(tetrahydrofuran), mixing the poly(tetrahydrofuran) with polyglycidyl ether of phenol-formaldehyde, ethyl methyl ketone, and isopropanol, and depositing one or more layers of the porosity-free phenolic epoxy onto a surface of a nanostructure.

These and other objects are achieved in whole or in part by the presently disclosed subject matter. Other objects and advantages of the presently disclosed subject matter will become apparent to those skilled in the art after a study of the following description and Drawings.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced. The accompanying drawings illustrate exemplary approaches of the disclosure, including the practical application of the principles thereof, as follows:

FIG. 1 is a block flow diagram depicting a method to fill a nanostructure with a porosity-free phenolic epoxy in accordance with one embodiment;

FIG. 2 illustrates a nanostructure filled with porosity-free phenolic epoxy;

FIG. 3 illustrates a nanostructure filled with a conventional phenolic epoxy; and

FIG. 4 shows a schematic of an example apparatus/system 400 according to embodiments of the disclosure.

### DETAILED DESCRIPTION

Methods and compounds in accordance with the present disclosure will now be described more fully hereinafter with reference to the accompanying drawings, where various embodiments are shown. The methods and compounds may be embodied in many different forms and are not to be construed as being limited to the embodiments set forth herein. Instead, these embodiments are provided so the disclosure will be thorough and complete, and will fully convey the scope of the methods to those skilled in the art. The terminology used herein is for the purpose of describing particular embodiments only and is not intended to be limiting of the presently disclosed subject matter.

The methods and compounds of the current technology provide porosity-free phenolic compounds that solve issues with filling nanostructures of semiconductor devices, such as dynamic random-access memory. The methods and compounds described here are based on unexpected findings of improved chemical and physical characteristics when use to create porosity-free compounds to uniformly fill nanostructures. This uniform, porosity-free fill provides advantages in nanostructure process development by creating a clear interface between processes for successive layering and sacrificial layering. The clear interfaces increase process control capabilities and increases the quality of the features.

Clear boundary distinction in nanostructure analysis is important for accurate measurements and continuous improvement processes. With this feedback advantage, developers see increased process control and tunability of nanostructure features.

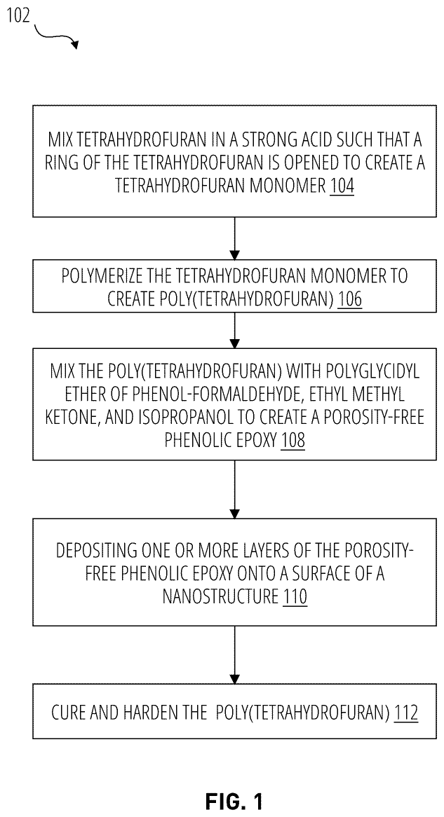

In the technology, a porosity-free phenolic epoxy is composed of tetrahydrofuran, polyglycidyl ether of phenol-formaldehyde, ethyl methyl ketone, and a secondary alcohol. In an example, the secondary alcohol in the phenolic epoxy is isopropanol. A process to produce and implement the porosity-free phenolic epoxy is described with respect to FIG. 1.

FIG. 1 is a block flow diagram depicting a method 102 to fill a nanostructure with a porosity-free phenolic epoxy in accordance with one embodiment.

In block 104, the method 102 mixes tetrahydrofuran in a strong acid such that a ring of the tetrahydrofuran is opened to create a tetrahydrofuran monomer. The tetrahydrofuran compounds disclosed herein are exemplified by the following chemical structure:

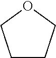

In block 106, the method 102 polymerizes the tetrahydrofuran monomer to create poly(tetrahydrofuran). The polymerization of the tetrahydrofuran to poly(tetrahydrofuran) is exemplified by the following reaction:

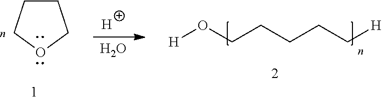

The mechanism for creating the poly(tetrahydrofuran) from the tetrahydrofuran via a polymerization reaction to create a polymer chain is exemplified by the following:

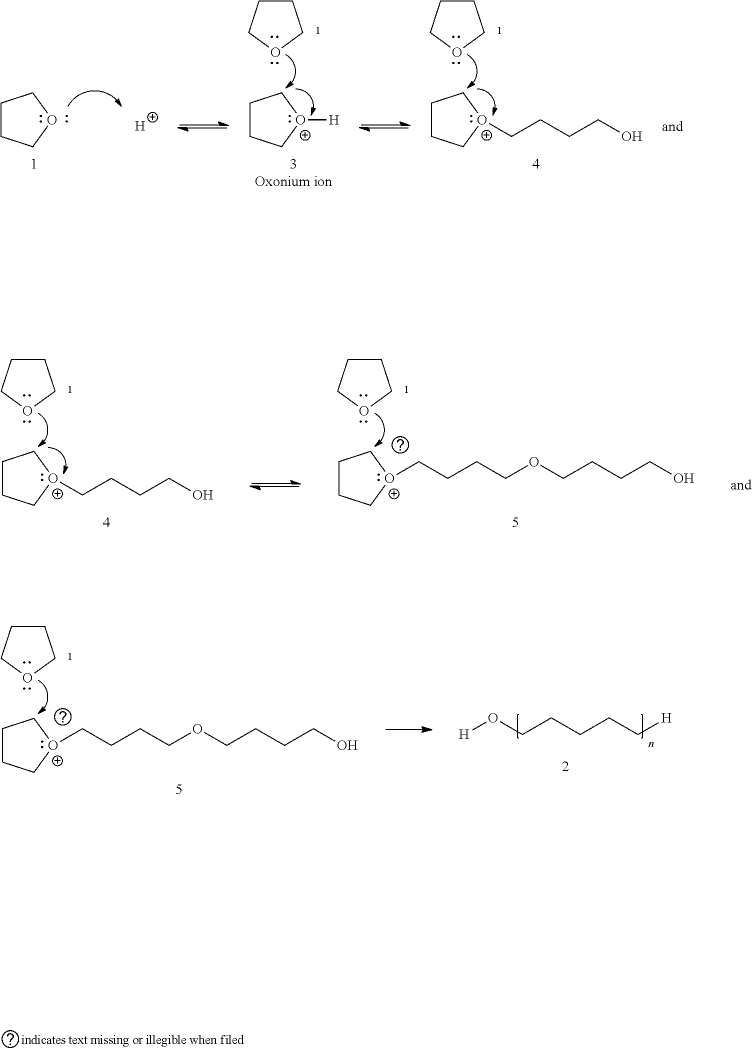

In some embodiments, the tetrahydrofuran may comprise 30 wt % to 50 wt % of the total phenolic epoxy. In other embodiments, the tetrahydrofuran may comprise 35 wt % to 45 wt % of the total phenolic epoxy. In other embodiments, the tetrahydrofuran may comprise 38 wt % to 43 wt % of the total phenolic epoxy. The polymerized poly(tetrahydrofuran) may comprise the same weight percentages as the tetrahydrofuran after polymerization.

In block 108, the method 102 mixes the poly(tetrahydrofuran) with polyglycidyl ether of phenol-formaldehyde, ethyl methyl ketone, and isopropanol to create a porosity-free phenolic epoxy.

The isopropanol is exemplified by the following chemical structure:

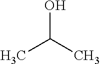

In some embodiments, the isopropanol may comprise 20 wt % to 40 wt % of the total phenolic epoxy. In other embodiments, the isopropanol may comprise 25 wt % to 35 wt % of the total phenolic epoxy. In other embodiments, the isopropanol may comprise 28 wt % to 32 wt % of the total phenolic epoxy.

The ethyl methyl ketone is exemplified by the following chemical structure:

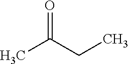

In some embodiments, the ethyl methyl ketone may comprise 2 wt % to 20 wt % of the total phenolic epoxy. In other embodiments, the ethyl methyl ketone may comprise 5 wt % to 15 wt % of the total phenolic epoxy. In other embodiments, the ethyl methyl ketone may comprise 8 wt % to 12 wt % of the total phenolic epoxy.

The representative segment of phenol-formaldehyde is exemplified by the following chemical structure:

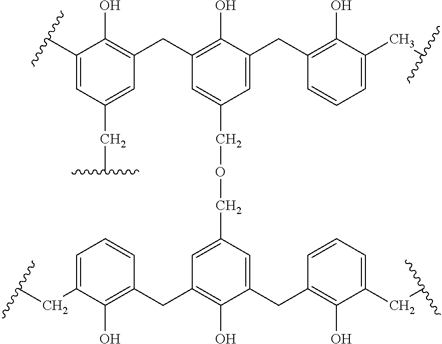 [SMILES: *Cc1cc(*)c(O)c(Cc2cc(COCc3cc(Cc4cccc(C*)c4O)c(O)c(Cc4cccc(C*)c4O)c3)cc(Cc3cccc(C*)c3O)c2O)c1]

In some embodiments, the polyglycidyl ether of phenol-formaldehyde may comprise 10 wt % to 30 wt % of the total phenolic epoxy. In other embodiments, the polyglycidyl ether of phenol-formaldehyde may comprise 15 wt % to 25 wt % of the total phenolic epoxy. In other embodiments, the polyglycidyl ether of phenol-formaldehyde may comprise 18 wt % to 23 wt % of the total phenolic epoxy.

In block 110, the method 102 deposits one or more layers of the porosity-free phenolic epoxy onto a surface of a nanostructure. For example, the phenolic epoxies can be used as an encapsulation and protection material for semiconductor packages.

For example, the phenolic epoxy may fill the nanostructure to protect the features of the nanostructure beneath the phenolic epoxy. The fill may then be removed uniformly at a later process step. Industry standard processes may use the fill as a sacrificial layer to protect SiN at a bottom of a feature of the nanostructure. The process may then remove the fill at later process step. A porous fill will not be sacrificed uniformly and can introduce risk of unintentionally damaging key structures of the nanostructure. A porosity-free phenolic epoxy as in method 102 provides a uniform fill that is free of voids and creates clear boundary differentiation with the nanostructure.

The application of the phenolic epoxy may be via any suitable application technology. For example, the phenolic epoxy may be applied to a nanostructure via spin coating, brush application, or chemical vapor deposition (CVD) in a CVD chamber.

In block 112, the polymerized poly(tetrahydrofuran) is cured and hardened. For example, the poly(tetrahydrofuran) may be exposed to heat in an industrial oven, via a heat jacket on a vessel, or in any other suitable manner.

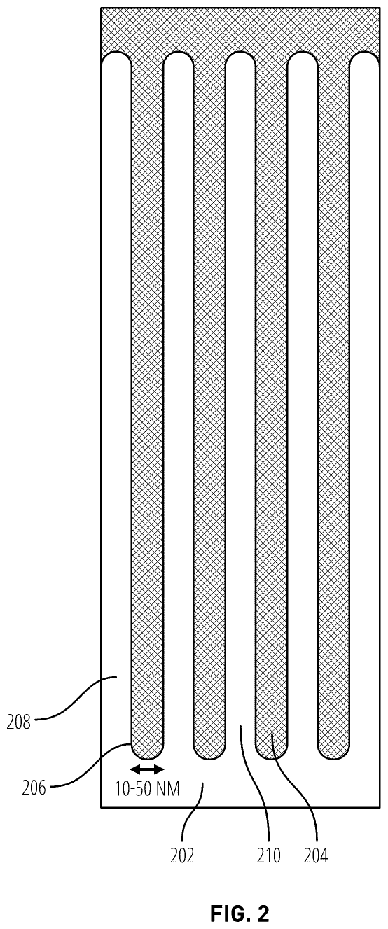

FIG. 2 illustrates a nanostructure 202 filled with porosity-free phenolic epoxy.

In the example of FIG. 2, a nanostructure 202 is illustrated with two vertical features 210 between two vertical nanostructure walls 208. The nanostructure 202 creates three wells or trenches to be filled with phenolic epoxy to provide encapsulation and protection material for the vertical features 210 and to improve metrology and imaging of the nanostructure 202. In the examples, the well to be filled with phenolic epoxy may be on a scale such as 5 nm to 50 nm. Other sizes, amounts, and shapes of gaps, trenches, bodies, wells, or structures may be filled with phenolic epoxy in similar applications. In some examples, gaps in the nanostructure 202 that are filled with the phenolic epoxy may be below 1 nm.

In the example, the phenolic epoxy fill 204 is placed into the wells in the nanostructure 202. The phenolic epoxy fill 204 based on the technology described herein is porosity-free. Bubbles, voids, pores, or other interruptions to the continuous fill 204 are not indicated in the illustration because the fill is porosity-free.

The porosity-free fill 204 penetrates deeper into the nanostructure 202 than a conventional epoxy fill. The fill 204 is thus more uniform at the top, middle, and bottom of the gaps in the nanostructure 202.

Further, the fill 204 creates a clean interface 206 with the nanostructure 202. When the fill is uniform and consistent, then the edges of the nanostructure 202 are clearly defined when imaged, such as in a TEM process. The color of the fill 204 is configurable to contrast with the nanostructure 202. The uniform, consistent fill 204 allows increased contrast and greater measurement accuracy. The porosity-free fill 204 provides greater boundary differentiation for enhanced process control and tunability.

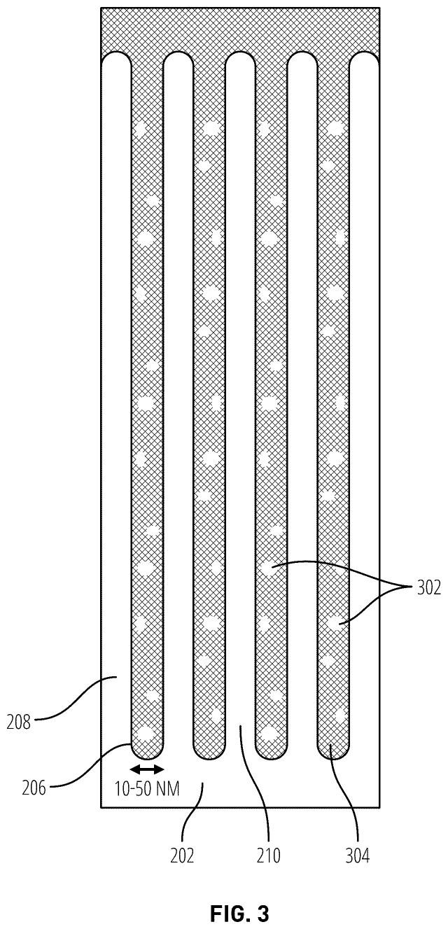

FIG. 3 illustrates a nanostructure 202 filled with a conventional phenolic epoxy fill 304.

In the example of FIG. 3, a nanostructure 202 is illustrated with two vertical features 210 between two vertical nanostructure walls 208 in a similar manner as described with respect to FIG. 2. The nanostructure 202 creates three wells to be filled to provide encapsulation and protection material for the vertical features 210 and to improve metrology and imaging of the nanostructure 202. However, in FIG. 3 the fill 304 is a conventional fill 304 and not the phenolic epoxy fill 204 described herein.

As illustrated, a conventional fill 304 does not fill the gaps in the nanostructure 202 with a porosity-free phenolic epoxy. The conventional fill 304 has voids 302 remaining in the conventional fill 304. The voids may be bubbles, gaps, or other empty zones of the conventional fill 304. The conventional fill 304 is unable to fully protect the nanostructure 202.

Further, the conventional fill 304 does not create a clean interface with the nanostructure 202. At least a portion of the voids 302 may be located at the interface between the conventional fill 304 and the nanostructure 202. When the conventional fill 304 is not uniform or consistent, then the edges of the nanostructure 202 are not clearly defined when imaged, such as in a TEM process. Further, the uniform color of the conventional fill 304 is compromised when the voids are present. With the color variances, a clear boundary differentiation with the nanostructure 202 is not created for proper imaging.

Alternative embodiments may use epoxies with other mixtures of chemical compounds to create the fill, such as another solvent. For example, an alternative technology replaces the isopropanol in the mixture with a solvent such as acetone. Other alternative embodiments may replace the isopropanol with solvents such as one or more of acetic acid, ammonia, ethanol, methanol, or 1-propanol. These and other solvents may provide some or all of the benefits of the epoxy using isopropanol. The alternative solvents may be used in a similar proportion or wt % as the examples using isopropanol recited herein. Other embodiments of phenolic epoxies add a diluent to the mixture.

A phenolic epoxy created in these conventional methods does not provide a porosity-free fill. The voids cause the fill to be non-uniform, porous, and ill-defined.

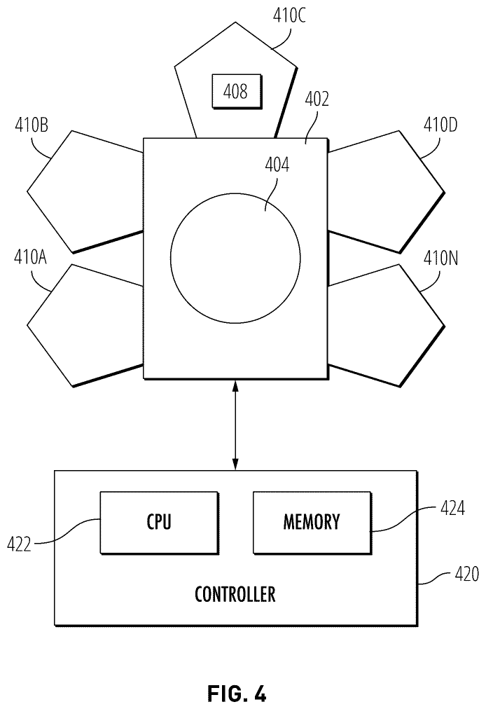

FIG. 4 shows a schematic of an example apparatus/system 400 according to embodiments of the disclosure. In some embodiments, the system 400 may be a cluster tool operable to perform processes necessary to form the devices described herein. Although non-limiting, the system 400 may include at least one central transfer station/chamber 402 and one or more robots 404 within the transfer station/chamber 402, wherein the robot 404 is operable to move a robot blade and a wafer to and from each of a plurality of processing chambers 410A-410N connected with, or positioned adjacent to, the transfer station/chamber 402. In some embodiments, the processing chambers 410A-410N may support various ion treatments, material deposition, material etching, and more. The particular arrangement of process chambers and components can be varied depending on the cluster tool and should not be taken as limiting the scope of the disclosure. In another example, one or more of the chambers may include multiple process regions within a same chamber, which permits a common supply of gases, common pressure control, and common process gas exhaust/pumping. Modular design of the system enables rapid conversion from one configuration to any other.

In some embodiments, processing chamber 410A may be a deposition chamber, such as a CVD chamber operable to deposit the phenolic epoxy over the nanostructure 202, as described above. Processing chamber 410B may be an etch chamber, and processing chamber 410C may house an ion processing tool. In some embodiments, processing chamber 410D may be operable to perform one or more thermal processes, such as an anneal.

A system controller 420 is in communication with the robot 404, the transfer station/chamber 402, and the plurality of processing chambers 410A-410N. The system controller 420 can be any suitable component that can control the processing chambers 310A-410N and robot(s) 404, as well as the processes occurring within the process chambers 310A-410N. For example, the system controller 420 can be a computer including a central processing unit 422, memory 424, suitable circuits/logic/instructions, and storage.

Processes or instructions may generally be stored in the memory 424 of the system controller 420 as a software routine that, when executed by the processor 422, causes the processing chambers 410A-410N to perform processes of the present disclosure. For example, the memory 424 may store instructions executable by the processor 422 to form a high-k dielectric layer within a trench of a transistor, form a bottom electrode within a lower portion of the trench, wherein the bottom electrode is formed over the high-k dielectric layer, form a low-k dielectric layer over the bottom electrode, and form a gate dielectric and a gate material over the low-k dielectric layer.

The software routine may also be stored and/or executed by a second processor (not shown) that is remotely located from the hardware being controlled by the processor 422. Some or all of the method(s) of the present disclosure may also be performed in hardware. As such, the process may be implemented in software and executed using a computer system, in hardware as, e.g., an application specific integrated circuit or other type of hardware implementation, or as a combination of software and hardware. The software routine, when executed by the processor 422, transforms the general-purpose computer into a specific purpose computer (controller) that controls the chamber operation such that the processes are performed.

While the following terms are believed to be well understood by one of ordinary skill in the art, the following definitions are set forth to facilitate explanation of the presently disclosed subject matter.

All technical and scientific terms used herein, unless otherwise defined herein, are intended to have the same meaning as commonly understood by one of ordinary skill in the art. References to techniques employed herein are intended to refer to the techniques as commonly understood in the art, including variations on those techniques or substitutions of equivalent techniques that would be apparent to one of skill in the art. While the following terms are believed to be well understood by one of ordinary skill in the art, the following definitions are set forth to facilitate explanation of the presently disclosed subject matter.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition. Also, even though the claims hereinafter may refer to substances, components and/or ingredients in the present tense (“comprises”, “is”, etc.), the reference is to the substance, component, or ingredient as it existed at the time just before it was first contacted, blended, or mixed with one or more other substances, components, and/or ingredients in accordance with the present disclosure. The fact that a substance, component, or ingredient may have lost its original identity through a chemical reaction or transformation during the course of contacting, blending, or mixing operations, if conducted in accordance with this disclosure and with ordinary skill of a chemist, is thus of no practical concern.

In describing the presently disclosed subject matter, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Following long-standing patent law convention, the terms “a”, “an”, and “the” refer to “one or more” when used in this application, including the claims. Thus, for example, reference to “a cell” includes a plurality of such cells, and so forth.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value or to an amount of a composition, dose, mass, weight, temperature, time, volume, concentration, percentage, etc., is meant to encompass variations of in some embodiments+20%, in some embodiments+10%, in some embodiments+5%, in some embodiments+1%, in some embodiments+0.5%, and in some embodiments+0.1% from the specified amount, as such variations are appropriate to perform the disclosed methods or employ the disclosed compositions.

The term “comprising”, which is synonymous with “including,” “containing,” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

What is claimed is:

1. A phenolic epoxy to use as a fill for nanostructures, the phenolic epoxy comprising:
poly(tetrahydrofuran);
polyglycidyl ether of phenol-formaldehyde;
ethyl methyl ketone; and
a solvent.

2. The phenolic epoxy of claim 1, wherein the solvent is isopropanol.

3. The phenolic epoxy of claim 1, wherein the solvent is one or more of acetone, acetic acid, ammonia, ethanol, methanol, and 1-propanol.

4. The phenolic epoxy of claim 1, wherein the poly(tetrahydrofuran) comprises 30 wt % to 50 wt % of the phenolic epoxy.

5. The phenolic epoxy of claim 1, wherein the solvent comprises 20 wt % to 40 wt % of the phenolic epoxy.

6. The phenolic epoxy of claim 1, wherein the polyglycidyl ether of phenol-formaldehyde comprises 10 wt % to 30 wt % of the phenolic epoxy.

7. The phenolic epoxy of claim 1, wherein the ethyl methyl ketone comprises 2 wt % to 20 wt % of the phenolic epoxy.

8. The phenolic epoxy of claim 1, wherein the phenolic epoxy is configured to fill a nanostructure gap without creating voids, bubbles, or other pores.

9. The phenolic epoxy of claim 1, wherein the phenolic epoxy is configured to fill a nanostructure gap with a uniform fill such that additional layers may be deposited without introducing porosity.

10. The phenolic epoxy of claim 1, wherein the poly(tetrahydrofuran) is formed from a polymerized tetrahydrofuran monomer.

11. The phenolic epoxy of claim 10, wherein the tetrahydrofuran monomer is formed from a tetrahydrofuran compound that has a ring structure of the tetrahydrofuran broken in a strong acid.

12. A method to fill a nanostructure with a phenolic epoxy, comprising:
providing a porosity-free epoxy comprising poly(tetrahydrofuran), polyglycidyl ether of phenol-formaldehyde, ethyl methyl ketone, and a solvent; and
depositing one or more layers of the porosity-free phenolic epoxy onto a surface of a nanostructure.

13. The method of claim 12, wherein the solvent is isoproponal.

14. The method of claim 12, wherein the solvent is one or more of acetone, acetic acid, ammonia, ethanol, methanol, and 1-propanol.

15. The method of claim 12, wherein providing the phenolic epoxy further comprises:
placing the tetrahydrofuran in a strong acid such that a ring of the tetrahydrofuran is opened to create a tetrahydrofuran monomer,
polymerizing the tetrahydrofuran monomer to create poly(tetrahydrofuran); and
mixing the poly(tetrahydrofuran) with the polyglycidyl ether of phenol-formaldehyde, the ethyl methyl ketone, and the solvent to create the porosity-free phenolic epoxy.

16. The method of claim 15, further comprising curing the polymerized poly(tetrahydrofuran).

17. The method of claim 15, wherein the poly(tetrahydrofuran) is mixed at 30 wt % to 50 wt % of the phenolic epoxy.

18. The method of claim 15, wherein the solvent is mixed at 20 wt % to 40 wt % of the phenolic epoxy.

19. The method of claim 15, wherein the polyglycidyl ether of phenol-formaldehyde is mixed at 10 wt % to 30 wt % of the phenolic epoxy.

20. The method of claim 15, wherein the ethyl methyl ketone is mixed at 2 wt % to 20 wt % of the phenolic epoxy.
